(19) United States
(12) Patent Application Publication
(10) Pub. No.: US 2023/0094309 A1
(43) Pub. Date: Mar. 30, 2023

(54) System For Real Time Videographic Production Ready Art

(71) Applicants: Claudia Diroma Messica, Beverly Hills (US); Kevin Esfandi, Beverly Hills (US)

(72) Inventors: Claudia Diroma Messica, Beverly Hills (US); Kevin Esfandi, Beverly Hills (US)

(21) Appl. No.: 17/953,167

(22) Filed: Sep. 26, 2022

Related U.S. Application Data
(60) Provisional application No. 63/305,027, filed on Jan. 31, 2022.
(60) Provisional application No. 63/248,975, filed on Sep. 27, 2021.

(51) Int. Cl. G06V 10/42; G06T 19/20; G06T 7/194; G06V 10/24; G06V 10/54; G06V 10/56

(52) U.S. Cl. CPC G06V 10/42; G06T 19/20; G06T 7/194; G06V 10/242; G06V 10/54; G06V 10/56; G06T 2207/10004

(57) ABSTRACT

A system 100 and computerized method for real time videographic digital and production ready art 118 having a computer capable of: retrieving video files and photographic files from storage 114; automatically selecting patterns or prints, deriving patterns or prints from the files; extracting complementary and/or similar patterns and/or prints as videographic digital and production ready art 118 from files; applying the extracted patterns, prints or both patterns and prints to real world products; and creating targeted still images from the production ready art 118 for commercial use and licensing.

### CROSS-REFERENCE TO RELATED APPLICATIONS

This application claims the benefit under 35 U.S.C. § 119(e) of U.S. Provisional Patent Application Ser. No. 63/248,975, filed on 2021 Sep. 27, and to U.S. Provisional Patent Application Ser. No. 63/305,027, filed on Jan. 31, 2022, the contents of which are incorporated herein by reference in their entirety.

### FIELD OF THE INVENTION

The present invention is in the technical field of production ready art and more particularly to a system for real time videographic digital and production ready art that is easy and flexible to use.

### BACKGROUND

The process of selecting designs for fabrics and other items is cumbersome and sometimes chaotic. Designers purchase prints from print vendors typically in person, spend hours sorting through the prints in a very unorganized fashion and then after selection of a print, spend many hours applying the selected print to designs and sampling.

For the step of applying a selected design or print to an item, such as clothing, there are programs like clo3d and Adobe 3D Substance Designer that allow the application of still graphics and materials through a 3d file however these programs lack any print selection mechanism and are cumbersome and tedious to apply to products when it comes to selecting how the print or design will be laid out on the product, such as on clothing or other upholstery and/or other products.

Currently designers can purchase stock videos and stock images, but there is no service to view a video and pull a single frame or frames from the video for design and/or print lay out purposes.

Therefore, there is a need for a system for real time videographic digital and production ready art that is easy and flexible to use, overcoming the limitations of the prior art.

### BRIEF DESCRIPTION OF THE DRAWINGS

The present invention overcomes the limitations of the prior art by providing a system 100 for real time videographic digital and production ready art that is easy and flexible to use.

These and other features, aspects and advantages of the present invention will become better understood with regard to the following description, appended claims, and accompanying Figures where:

FIG. 1 is a drawing of a system for real time videographic digital and production ready art that is easy and flexible to use, according to one embodiment of the present invention;

FIG. 2 is an uploaded video useful in the system of FIG. 1;

FIG. 3 is another uploaded video useful in the system of FIG. 1 on a smart device;

FIG. 4 is a digital light table for viewing individual frames of production ready art;

FIG. 5 is a group of individual frames of production ready art;

FIG. 6 is a sample of the uploaded design file applied to the production ready art;

FIG. 7 is a flowchart diagram of certain steps which may be in a computerized method to use the system of FIG. 1; and

FIG. 8 is a flowchart diagram of some step of a computerized method to use the system of FIG. 1 for non-fungible tokens (NFT's); and

FIG. 9 is an image of a virtual catwalk useful for the system of FIG. 1.

### SUMMARY

What is provided is a system 100 for real time videographic digital and production ready art 118 comprising: one or more than one computer 102, 104, 106, 108, 110; a 1 operably connected to the one or more than one computer, where the central computer comprises, a storage 114, memory and one or more than one processor capable of executing instructions on the one or more than one processor for: 1) retrieving one or more than one video file 122 from a storage 114; 2) retrieving one or more than one photographic file from a storage 114; 3) executing the instructions retrieved from the storage 114 for automatically selecting patterns or prints, deriving patterns or prints from the one or more than one video file 120, the one or more than one photographic file or both the one or more than one video file 122 and the one or more than one photographic file; 4) extracting complementary and/or similar patterns and/or prints as videographic digital and production ready art 118 from the one or more than one video file 120, the one or more than one photographic file or both the one or more than one video file 122 and the one or more than one photographic file; 5) applying the extracted patterns, prints or both patterns and prints to real world products; and 6) creating targeted still images from the production ready art 118 for commercial use and licensing. The computer and the central server 112 can be the same computer. The uploaded design files are selected from the group consisting of an outline, a CAD design file 120, a 2D image or a 3D image 122.

The system 100 also has instructions for overlaying an extracted patterns, prints over a still image and moving the still image by rotating the still image, offsetting the still image, or any other manipulation that can be done with the still image. Additionally, the system 100 is capable of exporting selected frames from the one or more than one video file 122 based on a time or a frame identifier to create a production ready art 118 file.

The system 100 can pull stored still images from different prints and patterns for viewing different orientations of the same patterns and prints on the same products or different products. A user can manipulate the design file that was uploaded and can change the background selected from a library of production ready art 118 file stored in the system 100. Also, the user can upload a video file 122 and/or design files and manipulate the files using the system 100. A plurality of time frames can be selected by the user to be used as the production ready art 118. The designer can swap and replace any of the individual time frames from either side of the digital light table. It is also noted that in some embodiments, various aspects of the pattern may be changed too such as color, line thickness, texture, and/or scale. The production ready art 118 comprises both a time frame 602 and a frame number 604 so that the production ready art 118 can be automatically retrieved by the system 100, exported and downloaded or stored by the user. The production ready art 118 is downloaded or sent to a third party fulfillment vendor to produce a tangible product.

The system 100 further comprises instruction for displaying a digital light board that can show the user one or more than one time frames from the videographic file for selecting one or more than one time frames, having associated time frame marks; wherein each time frame mark can be compared with other time frame marks for a final selection by the user for the production ready art 118.

There is also presented a computerized method for real time videographic digital and production ready art 118, having the following steps of: a) logging onto the system 100; b) uploading a design file that is stored in the system 100 under a user's credentials; c) uploading a video file 122 that is stored under the user's credentials; d) selecting a video to use from a library of stored videos; e) displaying a design file of a product in the foreground with the selected video playing in the background; f) displaying a frame stamp and a time stamp to identify individual frames of the video in the background; g) manipulating the design file over the video to find one or more frames or time periods for selecting production ready art 118; h) exporting one or more than one design combined with the video file 122 to a production ready file format; i) exporting variations of the design combined with the video file 122 using the selected frame stamp or a time stamp so that multiple complete files can be exported; and j) selecting the exported files for production. Steps c) through i) use a photographic file in place of in combination with the video file 120. The method also includes the steps of: a) placing the production ready art 118 in a digital experience for other's to view; b) minting one or more than one design into a non-fungible token; and c) publishing the one or more than one design and the non-fungible token. During the design step where the one or more than one design is developed further includes the steps of: a) rendering one or more than one design; b) saving the entire project is saved to the storage 114; wherein each of the one or more than one design can be added to a collection.

Moreover, the method comprises the steps of: a) displaying the design with the production ready art 118 on garments and collections on a virtual catwalk, wherein, the virtual catwalk comprises a 360 degree view of the designs with the production ready art 118 and/or collections; b) changing the background themes of the virtual catwalk; c) merging the virtual stage in the background with the selected designs and collections being shown; d) presenting products and collections to teams, buyers, and customers for production in real life and/or digital worlds, wherein the library of designs stored in the system 100 are integrate into the digital world for digital space customization.

### DETAILED DESCRIPTION OF THE INVENTION

The present invention overcomes the limitations of the prior art by providing a system 100 for real time videographic digital and production ready art 118 that is easy and flexible to use.

The system 100 greatly streamlines and shortens the amount of time that is taken shopping and looking for patterns, applying them to production drawings, and the approval process involved in design for design teams. Traditionally designers would have to look through countless pattern books either digital or analog and sort through them. There is no other platform or software that allows patterns to be pulled from photos or videos for application on real world products. The system 100 enables the use of photos and video to provide a unique mechanism for selecting patterns or prints, deriving patterns or prints, and applying patterns or prints to a product but allows the designer to pull complementing and similar patterns/prints seamlessly. Using the system 100 design, pattern selection, and pattern placement, create licensable still images from a video. Licensing refers to the patterns and prints stored in the system 100 that will be licensed on a per image basis prior to exporting or downloading any production ready art 118. The from a system 100 provider. Other pattern and print owners can also license their image and video stock to the designers using the system 100. The user can be granted a paid license by a subscription purchased in advance or at the time prior to exporting/downloading the production ready art 118.

Additionally, overlaying a still image, such as, for example an outline, a .cad design file 120, or a 3D image 122, on the video and being able to move the still image by rotating it, offsetting it or any other manipulation that can be done with the design file provides flexibility that was not possible before without major costs and time. When the designer or design team finds the image or images that they want to use, the images can exported out as selected frames based on time or frame identifiers to a production ready art 118 file and downloaded or sent to printers, editors, and others involved in the pattern or print application and product production process.

The system 100 provides a major competitive advantage in being able to isolate frames from a video for licensing from a cost perspective, because the entire video does not have to be licensed, only the frames used. Additionally, the system 100 is faster in showing patterns that can be viewed on a cut ready or 3D design almost instantaneously. Tremendous amounts of time will be saved by utilizing the system 100 for both initial design phases but also for ancillary and complementary products because of the way the system 100 can pull stills from different prints and patterns and/or can enable viewing of different orientations of the same patterns and prints on the same products or different products quickly.

Any and all dimensions specified in this disclosure are by way of example only and are not intended to be limiting. Further, the proportions shown in these figures are not necessarily to scale. As will be understood by those with skill in the art with reference to this disclosure, the actual dimensions and proportions of any system 100, any device or part of a system 100 or device disclosed in this disclosure will be determined by its intended use.

Methods and devices that implement the embodiments of the various features of embodiments of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific details. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. The flowcharts and block diagrams in the figures can illustrate the architecture, functionality, and operation of possible implementations of system 100s, methods and computer programs according to various embodiments disclosed. In this regard, each block in the flowchart or block diagrams can represent a module, segment, or portion of code, that can comprise one or more executable instructions for implementing the specified logical function(s). It should also be noted that, in some alternative implementations, the functions noted in the blocks may occur out of the order noted in the figures. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function. Additionally, each block of the block diagrams and/or flowchart illustration, and combinations of blocks in the block diagrams and/or flowchart illustration, can be implemented by special purpose hardware-based system 100s that perform the specified functions or acts, or combinations of special purpose hardware and computer instructions.

Moreover, a storage 114 may represent one or more devices for storing data, including read-only memory (ROM), random access memory (RAM), magnetic disk storage 114 mediums, optical storage 114 mediums, flash memory devices and/or other non-transitory machine readable mediums for storing information. The term “machine readable medium” includes, but is not limited to portable or fixed storage 114 devices, optical storage 114 devices, wireless channels and various other non-transitory mediums capable of storing, comprising, containing, executing or carrying instruction(s) and/or data.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage 114 medium or other storage 114(s). One or more than one processor may perform the necessary tasks in series, distributed, concurrently or in parallel. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc. and are also referred to as an interface, where the interface is the point of interaction with software, or computer hardware, or with peripheral devices.

In the following description, certain terminology is used to describe certain features of one or more embodiments of the invention.

The term “smart device” refers to any Internet connected device with a display that can be used to upload, download and view multimedia.

The term “production ready art 118” refers to print ready copy for publication online or in printed publications, such as a magazine with at least a 300 dpi resolution.

The term “video file” refers to any multimedia file comprising a resolution of at least 300 dpi at the scale of the garment for printing purposes, and a sample resolution that is lower resolution used to quickly review potential production ready art 118 that is used prior to a final selection and download of the production ready art 118.

The term “design file” refers to .cad, 3D, line drawing, and any other file format of a product that can be overlaid with a video file 122 to shown many different patterns and options to one or more than one designer to make production ready art 118.

Various embodiments provide a system 100 for real time videographic digital and production ready art 118. One embodiment of the present invention provides a system 100 For Real Time videographic digital and production ready art 118. In another embodiment, there is provided a method for using the system 100. The system 100 and method will now be disclosed in detail.

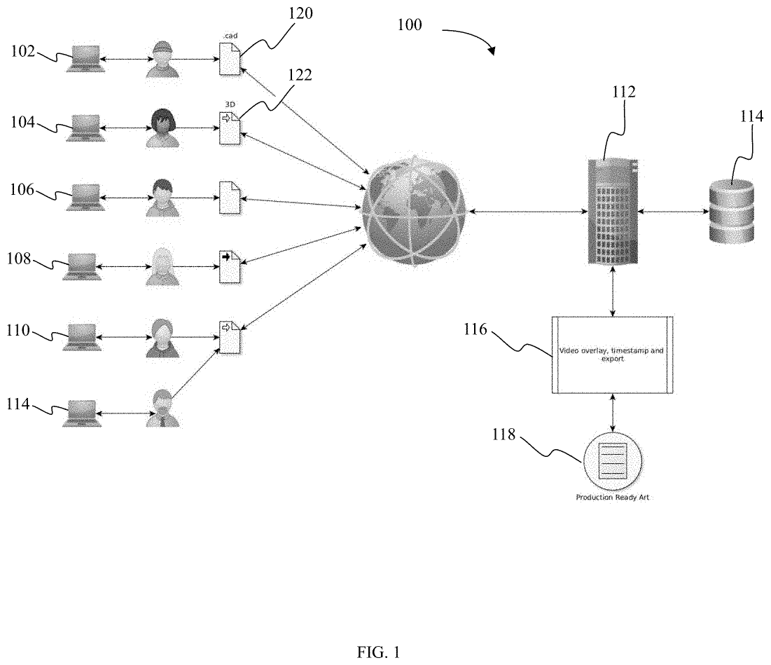

Referring now to FIG. 1, there is shown a drawing of a system 100 for real time videographic digital and production ready art 118 that is easy and flexible to use, according to one embodiment of the present invention.

The system 100 provides computer implemented instructions executable on one or more processors for a user to upload a video or still image and utilizing the uploaded design file overlaid over various selected videos to create targeted still images for commercial use and licensing. The system 100 provides a faster way for designers to pull and buy patterns to create production ready art 118, but also to sell the videos to the fashion market using the design files output from the system 100. The uploaded design file is necessary to show the dimensions of the usable surface area that can receive a print, and the video provides a way to readily change and select from a large amount of potential patterns as well as to print easily and quickly for any selected pattern.

The system 100 provides video artists, designers, design teams, and creators the opportunity to license still images and whole videos to clients for commercial use in a way never done before. Prior to this invention, video art was generally more difficult to monetize and portray than still art due to the complexity and time involved.

The system 100 streamlines and shortens the amount of time that is taken by designers shopping for patterns, applying them to production drawings, reviewing the combined result and obtaining approval of the design. Traditionally designers would look through countless pattern books, either digital or analog and sort through them. There is no other platform or software that allows patterns to be pulled from videos for application on real world products. Allowing the use of video not only provides a unique mechanism for deriving the patterns or prints, but allows the designer to pull complementing and similar patterns/prints seamlessly.

The designer can manipulate the design file that was uploaded and can change the background video to any selected from a library provided with the system 100. Alternatively, the designer can upload their own video and design files and manipulate the files using the system 100. Such as, for example, moving a garment design or move the video. The system 100 provides a digital light board that can display specific time frames of video created by the above process and from that set of time frames, the designer can select specific frames that have associated frame marks. Each specific frame mark can then be compared with other frame marks as the potential final selection for the production ready art 118 which may use the same pattern in various positions on the product to which it is to be applied and/or a different pattern or patterns in the same and/or various positions on the product to which it is to be applied. Alternatively, a plurality of time frames can be selected as a video to be used as the production ready art 118.

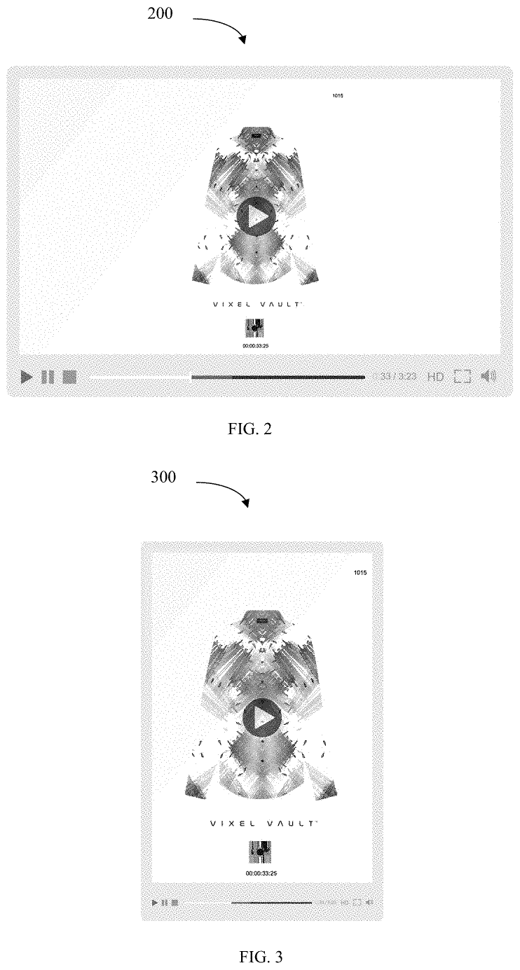

Referring now to FIGS. 2 and 3, there is shown an uploaded video 200 and 300 useful in the system 100 of FIG. 1. FIG. 2 is an example of the system 100 operating on a computer 200. However, in this embodiment, the system 100 is a software as a service model. This allows low computing power smart devices 300, such as, for example, a tablet as shown in FIG. 3 to upload design files 120 and perform all the operations necessary to make production ready art 118. This opens up the design process to anyone with a smart phone or a tablet and an Internet connection. As will be understood by those with skill in the art with respect to this disclosure, a stand alone software version is also contemplated.

In another embodiment, it is contemplated that the designer can upload a video file 122 or design file or both a video file 122 and a design file 120 for use in the system 100. In the first example, the designer can preselect and use one or more than one design file 120 and apply the uploaded video file 122 to the one or more than one design file 120. The resultant production ready art 118 can then be download or sent to a third party fulfillment vendor to produce a tangible product, such as for example, a vinyl wrap for a vehicle, a coffee mug, a pen, a piece of furniture, various art, tableware, apparel, fashion accessories, backpacks, among other items. The list provided below is a non-exhaustive list of potential use cases by category for the system 100 described herein:
FASHION
All, Clothing, T-Shirts, Button Down Shirts, Tank Tops, Dresses, Hats, Hoodies, Sweatshirts, Jackets, Blazers, Coats, Jeans, Denim, Underwear, Lingerie, Boxers, Briefs, Loungewear, Sleepwear, Swimsuits, Bikinis, Swimming Trunks, Wetsuits, Sports Bras, Jumpsuits, Overalls, Playsuits, Leotards, Leggings, Trousers, Joggers, Shorts, Skirts, Socks, All Shoes, Sneakers, Boots, Slippers, Sandals, Heels, Mules, Foot Coverings, Disposable Sneaker Cover Protectors.
ACCESSORIES
All Bags, Handbags, Sports Bags, Backpacks, Drawstring Bags, Duffle Bags, Briefcases, Luggage, Trunks, Suitcases, Wallets & Cardholders, Passport Covers, Cosmetics Bags, Toiletry Bags, Tote Bags, Zipper Pouches, Water Bottles, Travel Mugs, Tech Accessories, Socks, Shoelaces, Undergarments, Scarves, Pins, Masks, Eye Masks, Pasties, Hats, Beanies, Gloves, Ties, Bow-Ties, Hair Accessories, Headscarf, Bandanas, Handkerchief, Lighters.
HOME DÉCOR
Tapestries, Throw Pillows, Rectangular Pillows, Floor Pillows, Throw Blankets, Blackout Curtains, Sheer Curtains, Wall Clocks, Rugs, Area Rugs, Wallpaper, Wall Murals, Clocks, Puzzles, Magnets, Acrylic Blocks, Vases, Lamps.
WALL ART & PRINTS
Art Board Prints, Canvas Prints, Framed Prints, Metal Prints, Mounted Prints, Photographic Prints, Posters, Tapestries.
FURNITURE
Cabinets, Benches, Bar Stools, Counter Stools, Side Tables, Coffee Tables, Gamer Chairs, Tables.
BED & BATH
Comforters, Duvet Covers, Pillow Shams, Shower Curtains, Bath Mats, Hand & Bath Towels, Shower Robes, Shower Slippers.
TABLETOP & OFFICE
Coffee Mugs, Plates, Cutlery, Placemats, Tea Cups, Water Bottles, Wine Chillers, Cutting Boards, Serving Trays, Coasters, Game Sets, Stickers, Notebooks, Stationary Cards, Acrylic Trays, Acrylic Boxes, Wrapping Paper, Calendars, Planners, Mouse Pads, Desk Mats, Tins, storage 114 Tins, Packaging, Gift Boxes, Playing Cards.
TECHNOLOGY
iPhone Cases, Android Cases, Smart Watch Bands, Laptop Cases and Sleeves, Hard Drives, Computer Skins, Airpod Cases. Audio Equipment.
OUTDOOR & LIFESTYLE
Yoga Mats, Yoga Towels, Water Bottles, Welcome Mats, Wine Chiller, Can Coolers, Beach Towels, Picnic Blankets, Slink Chairs, Folding Stools, Folding Chairs, Floor Cushions, Sun Shades, Umbrellas, Swim & Pool Accessories, Surfboards, Sports Gear, Skateboards, Bicycles.
STICKERS
Car Stickers, Helmet Stickers, Laptop Stickers, Hydro Flask Stickers, Holographic Stickers.

The options for customization and personalization of custom or pre-made product design files 120 and videos to any tangible product, are endless using the system 100.

Referring now to FIG. 4, there is shown a digital light table 400 for viewing individual frames 402 of production ready art 118. As can be seen, a selected time frame 402 of individual frames 404 is shown from a selected time frame 402 of the combined video. Individually selected time frames are shown on the right hand side of the digital light table. The designer can swap and replace any of the individual time frames 402 from either side of the digital light table. It is also noted that in some embodiments, various aspects of the pattern may be changed too such as color, line thickness, texture, and/or scale.

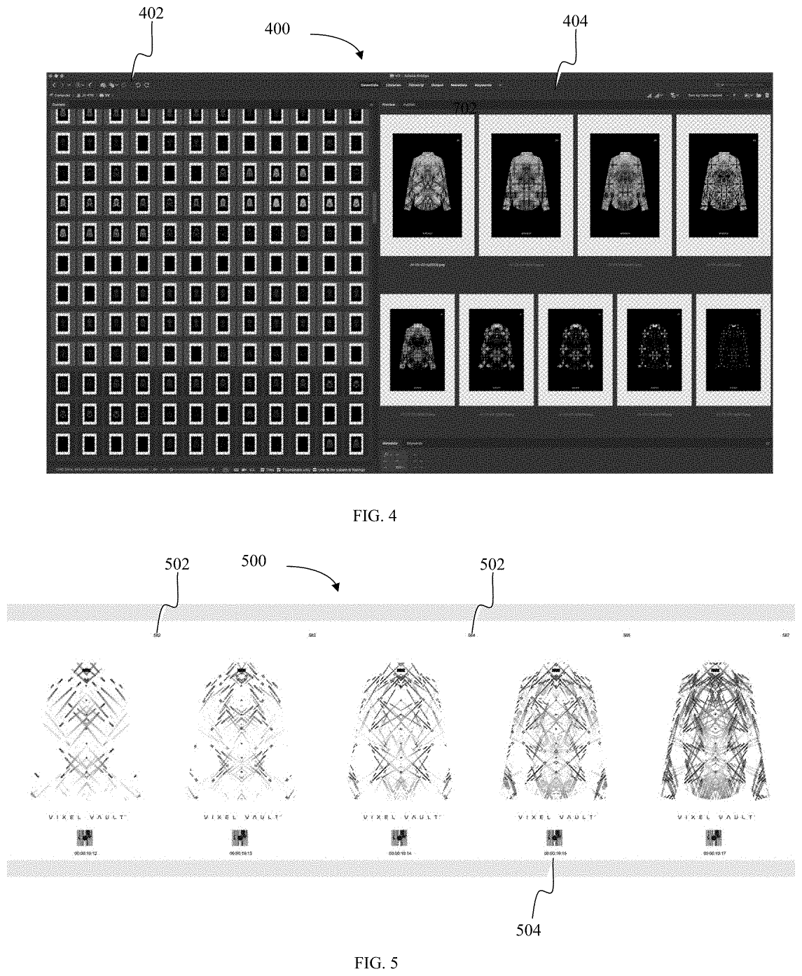

Referring now to FIG. 5, there is shown a group of individual frames 500 of production ready art 118. After the selection process is complete, each individual time frame 504 can be shown with a frame mark 502 included in the time frame image. This allows the designer to find one or more specific frames to export.

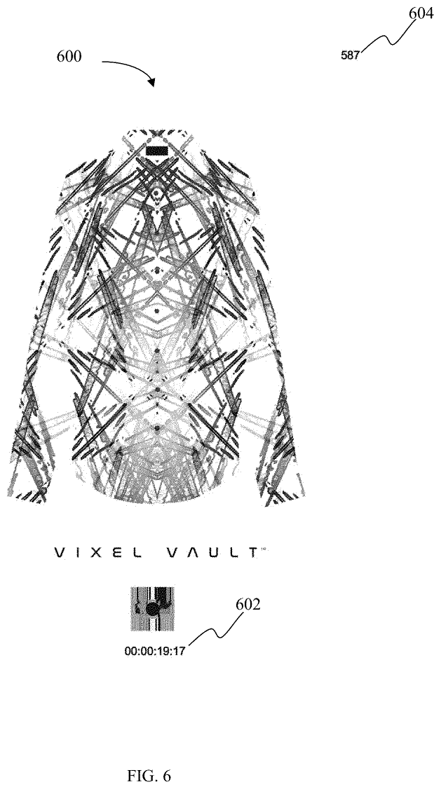

Referring now to FIG. 6, there is shown a sample of the uploaded design file 600 applied to the production ready art 118. As can be seen, this is the final selection for the production ready art 118. Both a time frame 602 and a frame number 604 are shown so that the final production ready art 118 can be automatically retrieved by the system 100, exported and downloaded or stored by the designer.

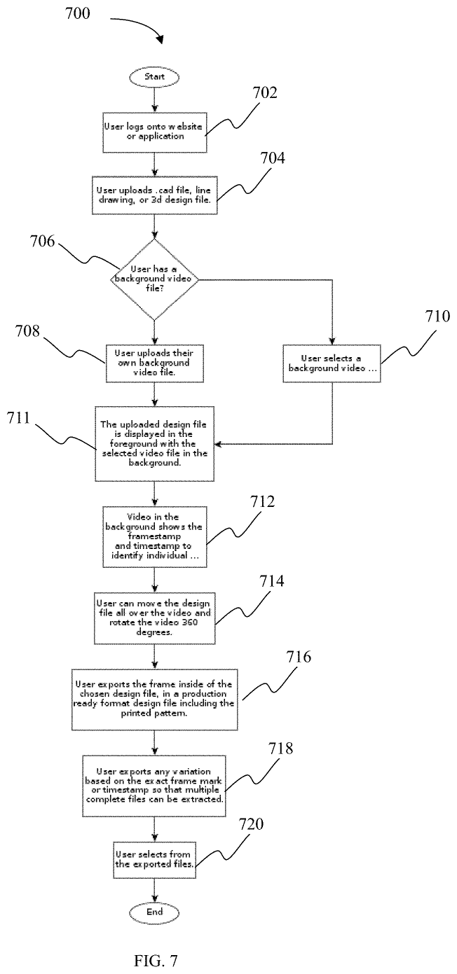

Referring now to FIG. 7, there is shown a flowchart diagram 700 of some step of a computerized method to use the system 100 of FIG. 1. In this embodiment, the system 100 is operating as a software service in the cloud. First, a user logs onto 702 the system 100. Then, the user uploads a design file 704 that is stored in the system 100 under the user's credentials. Next, if the user has a video file 122 to use 706, that video file 122 is uploaded 710 and stored under the user's credentials. Otherwise, the user selects a video to use 708 from a library of videos stored in the system 100 or otherwise accessed by the system 100. Then, the design file of the product such as clothing is displayed 711 in the foreground with the selected video playing in the background 712. Next, the video in the background displays 716 a frame stamp and a time stamp to identify individual frames of the video. Then, the user manipulates the design file over the video to find one or more frames or time periods to use in selecting production ready art 118. Next, the user exports 714 one or more than one design/video file 122 to a production ready file format. Then, the user exports 716 any variation of the design/video file 122 using the selected frame stamp or a time stamp so that multiple complete files can be exported 718. Finally, the user selects 720 and uses the exported files. The user may repeat the process or parts of the process with another video of a pattern or print and/or with another product design file.

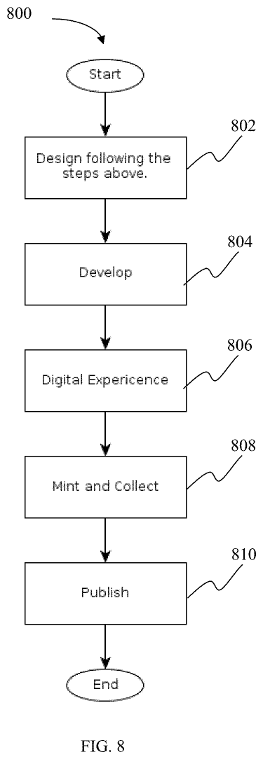

Referring now to FIG. 8, there is shown a flowchart diagram 800 of some step of a computerized method to use the system 100 of FIG. 1 for non-fungible tokens (NFT's). As can be seen, the computerized method comprised five steps. First one or more than one design is selected 802 (as outlined above). Then the design is fully developed 804. Next, the design is placed in a digital experience 806, such as, for example, a virtual catwalk, for other's to view. Then, the one or more than one design is minted 808 into a NFT that can then be collected. Finally, the one or more than one design and the NFT are published 810. Each step of the method is discussed in detail below.

Design

In this step the one or more than one design is developed. This includes a rendering process. Once the one or more than one design has been rendered, the entire project is saved. Each of the one or more than one design can be added to a collection or the user can create a new collection for the remaining steps.

Digital Experience

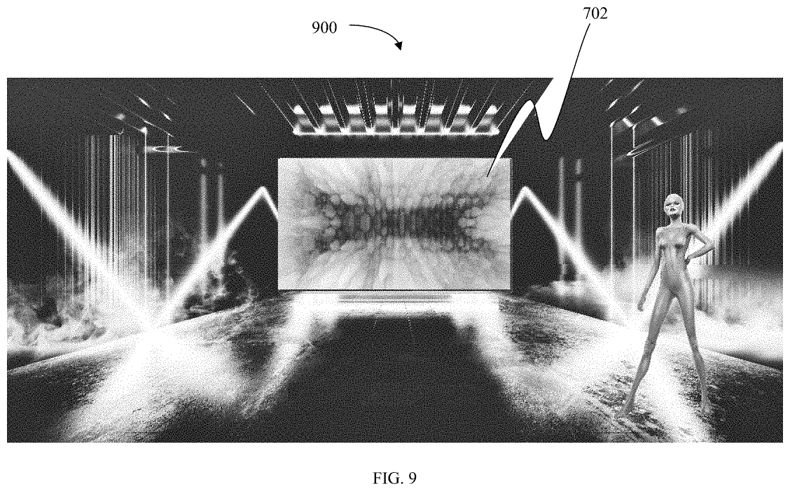

Referring now to FIG. 9, there is shown an image of a virtual catwalk 900 useful for showcasing garments and collections. Preferably, the virtual catwalk 900 comprises a 360 degree view of the designs and/or collections. In this step, the user has the ability to change background themes of the virtual catwalk 900. The virtual stage 902 in the background can be integrated with the selected designs/collections being shown. This allows designers and creatives the ability to present their specialized products and collections to their teams, buyers, and customers for production in real life and or for digital worlds, commonly refereed to as the metaverse.

Mint & Collect

The virtual catwalk runway experience, products, and garments, can be minted into NFT's. The user will be able to connect their cryptocurrency wallets, to these crypto items. All parts of the system 100 will be fully integratable with any cryptocurrency platform. First, everything must be prepared using an NFT process. Then, the NFT's are then put into a user's crypto-wallet.

The collection step provides instructions so that the integrated outfits can be shown to users on various Internet platforms, such as, for example, Twitch, for use and collection by video games, and video game players. The designers/collection for particular characters can be created as described above in both virtual clothing and in real life. This way a gamer can wear the clothing of their character or avatar.

Publish

In this step, the system 100 comprises instructions to prepare the NFT for exporting and publishing for the digital world, or Metaverse.

In yet another embodiment, the system 100 can also integrate the library of designs stored in the system 100 into the digital world (metaverse) for digital space customization.

What has been described is a new and improved system 100 for a system 100 for real time videographic digital and production ready art 118 that is easy and flexible to use, overcoming the limitations and disadvantages inherent in the related art.

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

What is claimed is:

1. A system 100 for real time videographic digital and production ready art 118, the computing system 100 comprising:
a. one or more than one computer;
b. a central server 112 operably connected to the one or more than one computer, where the central computer comprises, a storage 114, memory and one or more than one processor capable of executing instructions on the one or more than one processor for:
1) retrieving one or more than one video file from a storage 114;
2) retrieving one or more than one photographic file from a storage 114;
3) executing the instructions retrieved from the storage 114 for automatically selecting patterns or prints, deriving patterns or prints from the one or more than one video file, the one or more than one photographic file or both the one or more than one video file and the one or more than one photographic file;
4) extracting complementary and/or similar patterns and/or prints as videographic digital and production ready art 118 from the one or more than one video file, the one or more than one photographic file or both the one or more than one video file and the one or more than one photographic file;
5) applying the extracted patterns, prints or both patterns and prints to real world products; and
6) creating targeted still images from the production ready art 118 for commercial use and licensing.

2. The system 100 of claim 1, wherein the one or more than one computer and the central server 112 are the same computer.

3. The system 100 of claim 1, further comprising instructions for overlaying an extracted patterns, prints over a still image and moving the still image by rotating the still image, offsetting the still image, or any other manipulation that can be done with the still image.

4. The system 100 of claim 1, further comprising instructions for exporting selected frames from the one or more than one video file based on a time or a frame identifier to create a production ready art 118 file.

5. The system 100 of claim 1, wherein the system 100 can pull stored still images from different prints and patterns for viewing different orientations of the same patterns and prints on the same products or different products.

6. The system 100 of claim 1, wherein the uploaded design file is selected from the group consisting of an outline, a CAD design file, a 2D image or a 3D image.

7. The system 100 of claim 1, wherein a user can manipulate the design file that was uploaded and can change the background selected from a library of production ready art 118 file stored in the system 100.

8. The system 100 of claim 1, wherein the user can upload a video file or design file or both a video file and a design file for use in the system 100 and manipulate the files using the system 100.

9. The system 100 of claim 1, wherein the system 100 further comprises instruction for displaying a digital light board that can show the user one or more than one time frames from the videographic file for selecting one or more than one time frames, having associated time frame marks; wherein each time frame mark can be compared with other time frame marks for a final selection by the user for the production ready art 118.

10. The system 100 of claim 1, wherein a plurality of time frames can be selected by the user to be used as the production ready art 118.

11. The system 100 of claim 1, wherein the production ready art 118 is downloaded or sent to a third party fulfillment vendor to produce a tangible product.

12. The system 100 of claim 1, wherein the user can swap and replace any of the individual time frames from either side of the digital light table. It is also noted that in some embodiments, various aspects of the pattern may be changed too such as color, line thickness, texture, and/or scale.

13. The system 100 of claim 1, wherein the production ready art 118 comprises both a time frame and a frame number so that the production ready art 118 can be automatically retrieved by the system 100, exported and downloaded or stored by the user.

14. A computerized method for real time videographic digital and production ready art 118, the method comprising:
a) logging onto the system 100;
b) uploading a design file that is stored in the system 100 under a user's credentials;
c) uploading a video file that is stored under the user's credentials;
d) selecting a video to use from a library of stored videos;
e) displaying a design file of a product in the foreground with the selected video playing in the background;
f) displaying a frame stamp and a time stamp to identify individual frames of the video in the background;
g) manipulating the design file over the video to find one or more frames or time periods for selecting production ready art 118;
h) exporting one or more than one design combined with the video file to a production ready file format;
i) exporting variations of the design combined with the video file using the selected frame stamp or a time stamp so that multiple complete files can be exported; and
j) selecting the exported files for production.

15. The method of claim 14, wherein the steps c) through i) use a photographic file in place of in combination with the video file.

16. The method of claim 14, further comprising the steps of:
a) placing the production ready art 118 in a digital experience for other's to view;
b) minting one or more than one design into a non-fungible token; and
c) publishing the one or more than one design and the non-fungible token.

17. The method of claim 15, wherein the design step where the one or more than one design is developed further includes the steps of:
a) rendering one or more than one design;
b) saving the entire project is saved to the storage 114; wherein each of the one or more than one design can be added to a collection.

18. The method of claim 17, further comprising the steps of:
a) displaying the design with the production ready art 118 on garments and collections on a virtual catwalk, wherein, the virtual catwalk comprises a 360 degree view of the designs with the production ready art 118 and/or collections;
b) changing the background themes of the virtual catwalk;
c) merging the virtual stage in the background with the selected designs and collections being shown;
d) presenting products and collections to teams, buyers, and customers for production in real life and/or digital worlds.

19. The method of claim 18, wherein the library of designs stored in the system 100 are integrate into the digital world for digital space customization.
